(19) United States
(12) Patent Application Publication
(10) Pub. No.: US 2011/0307522 A1
(43) Pub. Date: Dec. 15, 2011

(54) Light Weight Transformation

(75) Inventors: Joseph Futty, Sammamish, WA (US); Danny Lange, Sammamish, WA (US); Ashley N. Feniello, Woodinville, WA (US); Graham A. Wheeler, Redmond, WA (US); Fernando P. Zandona, Sammamish, WA (US)

(73) Assignee: Microsoft Corporation, Redmond, WA (US)

(21) Appl. No.: 12/797,168

(22) Filed: Jun. 9, 2010

(51) Int. Cl. G06F 17/30; G06F 15/16

(52) U.S. Cl. 707/802; 709/246; 707/E17.115

(57) ABSTRACT

A transformation engine and transformation processes may reduce computational resources used by a client or a server, such as during the consumption of a document. According to some implementations, a data stream is received in a first format over a network. A mapping template may be associated with the data stream. A forward-traversal of the mapping template may be performed without the accumulation of an intermediate state. Following the traversal of the mapping template, an output stream is emitted in a second format.

### BACKGROUND

Online documents accessed by a client or a server may be transformed using a transformation processor such as an XSL Transformation (XSLT) processor. The XSLT processing model utilizes a source document, a stylesheet and an XSLT processing engine to produce a result document. The XSLT processing model follows a fixed algorithm, building a source tree from the source document. The model processes the source tree's root node, finding in the stylesheet a matching template for that node, and evaluating the template's contents. Instructions in each template generally direct the processor to either create nodes in the result tree, or process more nodes. Output is generally derived from the result tree.

Processing web applications using such a model may present obstacles for the client or the server. For example, when a client or a server retrieves a complex data structure from a third party service, the computational resources required to consume the data structure is great, and the time to create an output document is considerable. Generally this is the result of the need to construct an intermediate structure prior to any output. The creation of an intermediate structure, such as an intermediate tree or index structure, dramatically increases the resources and time required by the client or server to create and deliver the output document.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In view of the above, this disclosure describes example methods, systems, and computer-readable media for implementing a transformation engine and transformation processes to reduce computational resources used by a client or a server during the consumption of a document.

In an example implementation, a data stream is received in a first format over a network. For example, the data stream may be in the form of an extensible markup language (XML) format, a simple object access protocol (SOAP) format, a JavaScript object notation (JSON) format, or any structured data format. A mapping template is then associated with the data stream. A forward-traversal of the mapping template is performed without the accumulation of an intermediate state. Following the traversal of the mapping template, an output stream is emitted in a custom binary format.

A transformation engine is used to transform an input stream from one format to an output stream in another format. For example, the transformation engine converts the input stream to a token stream. The tokens of the token stream are used to traverse a mapping template associated with the input stream, resulting in the production of an output stream.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical items.

FIG. 1 is a schematic of an illustrative environment of a transformation framework.

FIG. 2 is a block diagram of an example computing device within the transformation framework of FIG. 1.

FIG. 3 is a diagram of an example transformation process within the transformation framework of FIG. 1.

FIG. 4 is a diagram of an example match template structure within the transformation framework of FIG. 1.

FIG. 5A and FIG. 5B are illustrations of an example transformation process within the transformation framework of FIG. 1.

FIG. 6A and FIG. 6B are a further illustration of an example transformation process within the transformation framework of FIG. 1.

FIG. 7A and FIG. 7B are a further illustration of an example transformation process within the transformation framework of FIG. 1

FIG. 8A and FIG. 8B are a further illustration of an example transformation process within the transformation framework of FIG. 1.

FIG. 9A and FIG. 9B are a further illustration of an example transformation process within the transformation framework of FIG. 1

FIG. 10 is a flow diagram of an example process to transform a data stream according to some implementations.

### DETAILED DESCRIPTION

Some implementations herein provide a transformation engine and transformation processes to reduce computational resources used by a client or a server during consumption of a document. More specifically, an example process may transform a complex data structure, such as, without limitation, an extensible markup language (XML) document, to a new data structure, such as a custom binary format, without allocating an intermediate tree or index structure. The transformation engine receives the complex data structure and utilizes an associated mapping template to emit a stream in any desired format.

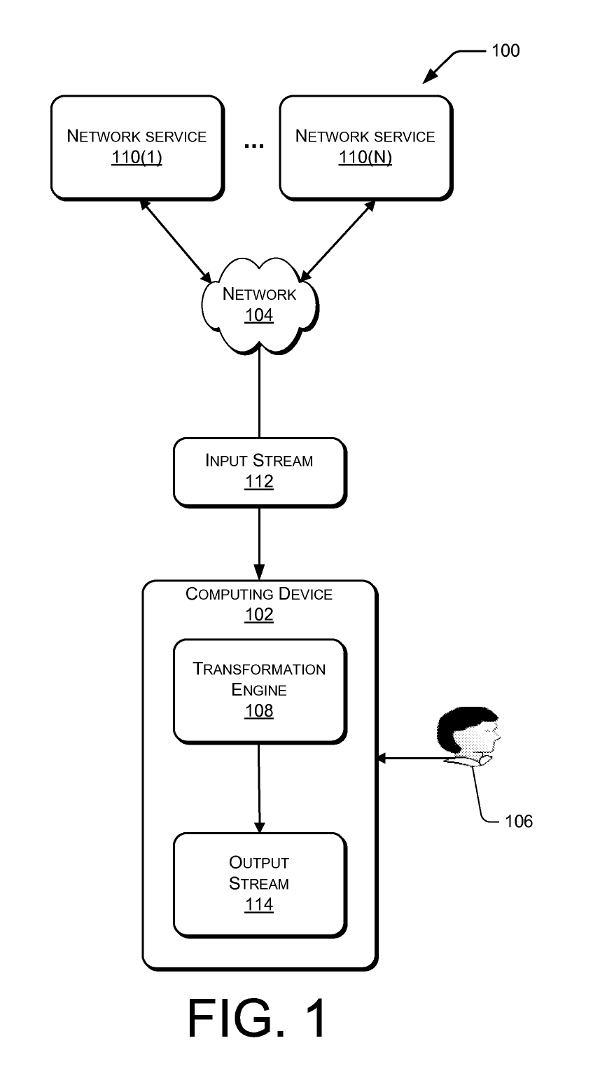

FIG. 1 is a block diagram of an example environment 100, which is used for the transformation of a document on a computing device. The environment 100 includes an example computing device 102, which may take a variety of forms including, but not limited to, a portable handheld computing device (e.g., a personal digital assistant, a smart phone, a cellular phone), a laptop computer, a desktop computer, a media player, a digital camcorder, an audio recorder, a camera, or any other similar device.

The computing device 102 may connect to one or more network(s) 104 and is associated with a user 106. The computing device 102 may include a transformation engine 108 to transform one or more documents or other data structures during consumption by the computing device 102. Transformation engine 108 may also, without limitation, be used to create output for printing, direct video displays, translate messages between different schemas, or make changes to a document within a scope of a single schema.

For example, as illustrated in FIG. 1, the user 106 may access a network service 110(1)-110(N) over network 104 to obtain an input stream 112. Transformation engine 108 may transform the input stream 112 to an output stream 114 for use on computing device 102. While FIG. 1 shows transformation engine 108 residing on computing device 102, it is to be appreciated that alternatively transformation engine 108 may reside on a server.

The network(s) 104 represent any type of communications network(s), including, but not limited to, wire-based networks (e.g., cable), wireless networks (e.g., cellular, satellite), cellular telecommunications network(s), and IP-based telecommunications network(s). The network(s) 104 may also include traditional landline or a public switched telephone network (PSTN), or combinations of the foregoing (e.g., Unlicensed Mobile Access or UMA networks, circuit-switched telephone networks or IP-based packet-switch networks).

The network services 110(1)-110(N) are illustrated in this example as web-based services available over the Internet, but may additionally or alternatively include services on a variety of other wide area networks (WANS), such as an intranet, a wired or wireless telephone network, a satellite network, a cable network, a digital subscriber line network, a broadcast, and so forth. The network services 110(1)-110(N) may include or be coupled to one or more types of system memory (not shown). The network services 110(1)-110(N) may communicate a data transmission, such as input stream 112, to the computing device 102. In one implementation, the data transmission is an XML transmission. In other implementations, the data transmission may include substantially real-time content, non-real time content, or a combination of the two. Sources of substantially real-time content generally include those sources for which content is changing over time, such as, for example, live television or radio, webcasts, or other transient content. Non-real time content sources generally include fixed media readily accessible by a consumer, such as, for example, pre-recorded video, audio, text, multimedia, games, or other fixed media readily accessible by a consumer.

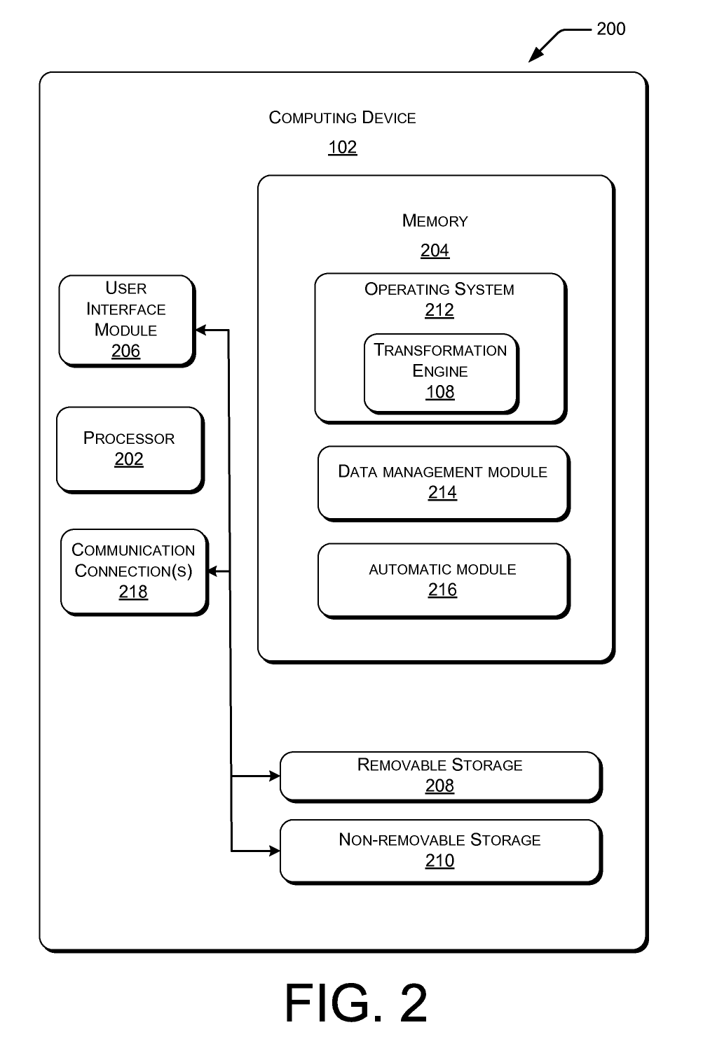

FIG. 2 is a schematic block diagram 200 of an example of computing device 102. In one example configuration, the computing device 102 comprises at least one general processor 202, a memory 204, and a user interface module 206. The general processor 202 may be implemented as appropriate in hardware, software, firmware, or combinations thereof. Software or firmware implementations of the general processor 202 may include computer or machine executable instructions written in any suitable programming language to perform the various functions described.

Memory 204 may store programs of instructions that are loadable and executable on the processor 202, as well as data generated during the execution on these programs. Depending on the configuration and type of server, memory 204 may be volatile (such as RAM) and/or non-volatile (such as ROM, flash memory, etc.). The computing device 102 may also include additional removable storage 208 and/or non-removable storage 210 including, but not limited to, magnetic storage, optical disks, and/or tape storage. The disk drives and their associated computer-readable medium may provide non-volatile storage of computer readable instructions, data structures, program modules, and other data for the computing device 102.

Memory 204, removable storage 208, and non-removable storage 210 are all examples of computer storage media. Additional types of computer storage medium that may be present include, but are not limited to, RAM, ROM, flash memory or other memory technology, CD-Rom, DVD, or other optical storage, magnetic cassettes, magnetic tape, magnetic disk storage (e.g., floppy disc, hard drive) or other magnetic storage devices, or any other medium which may be used to store the desired information.

Turning to the contents of memory 204 in more detail, the memory may include an operating system 212. In one implementation, the memory 204 includes a data management module 214 and an automatic module 216. The data management module 214 stores and manages storage of information, such as images, return on investment (ROI), equations, and the like, and may communicate with one or more local and/or remote databases or services. The automatic module 216 allows the process to operate without human intervention. The computing device 102 may also contain communication connection(s) 218 that allow processor 202 to communicate with other services. Communications connection(s) 218 is an example of a communication medium. A communication medium typically embodies computer-readable instructions, data structures, and program modules. By way of example and not limitation, communication medium includes wired media such as a wired network or direct-wired connection, and wireless media such as acoustic, RF, infrared and other wireless media.

The operating system 212 comprises a transformation engine 108. The transformation engine 108 may be a standalone application or a software component. In some implementations, the transformation engine is a processor utilized to process input stream 112 to produce output stream 114. To facilitate the process and reduce the resources utilized by the computing device 102, the transformation engine may utilize a custom binary format such as, without limitation, WAP Binary XML (WBXML), Binary JSON (BSON), or the like. For example, in one implementation, the input stream 112 is an XML stream. The transformation engine 108 may choose a corresponding customary binary format, reducing the resources utilized by the computing device 102 and maintaining the XML data structure of the input stream 112. Preservation of the XML data structure ensures an accurate transmission between the network services 110(1) and the computing device 102.

The computing device 102, as described above, may be implemented in various types of systems or networks. For example, the computing device may be a stand-alone system, or may be a part of, without limitation, a client-server system, a peer-to-peer computer network, a distributed network, a local area network, a wide area network, a virtual private network, a storage area network, and the like.

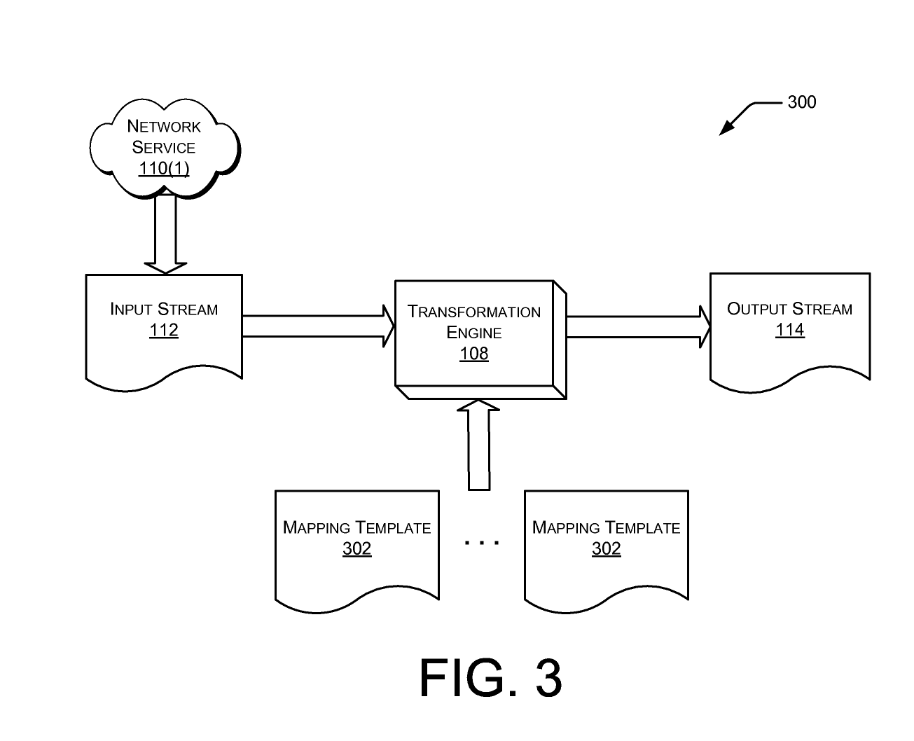

FIG. 3 illustrates an example transformation process 300. The network service 110(1) communicates an input stream 112 to transformation engine 108. In one implementation, input stream 112 is an XML document. Alternatively, the input stream may be in the form of, without limitation, JavaScript Object Notation (JSON), simple object access protocol (SOAP), or the any other structured format. The transformation engine generally also takes in a mapping template 302. Mapping template(s) 302(1)-302(N) may each be a match tree typically constructed “offline” and accessible for multiple requests by transformation engine 108. Mapping templates 302(1)-302(N) may be hosted externally of the transformation engine 108, hosted on the computing device 102, or embedded into the transformation engine 108.

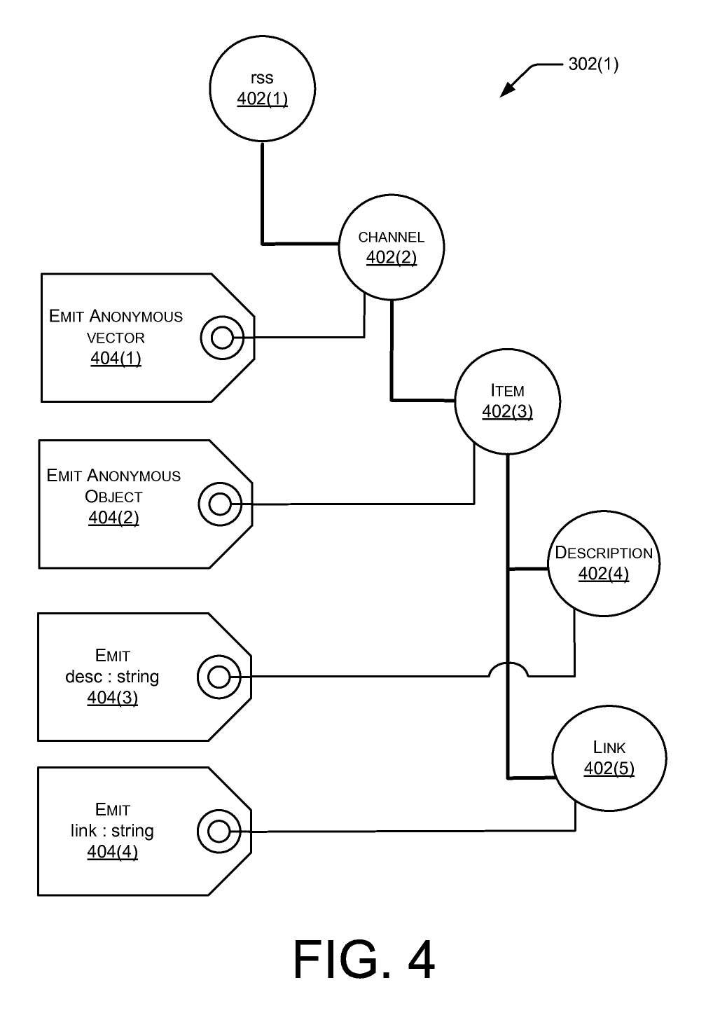

FIG. 4 illustrates an example mapping template 302(1) and expresses a tree 400 of data anticipated from the input stream 112. Each node 402(1)-402(5) of tree 400 may be optionally tagged with information about what the node may emit in the output stream 114 when the node is recognized by the transformation engine 108. For example, a channel node 402(2) emits an anonymous vector 404(1), an item node 402(3) emits an anonymous object 404(2), and a description node 402(4) and a link node 402(5) each emit a named string 404(3) and 404(4), respectively.

In one implementation, the named strings emitted in the optional tags 404(3)-404(4) need not match the node. For example, description node 402(4) does not match the emitted named string 404(3) (desc : string), representing what information is to be emitted in the output stream 114. Alternatively, the names emitted in the optional tags 404(3)-404(4) may match the corresponding node.

As illustrated in FIG. 4, not every node need emit anything, as shown by really simple syndication (RSS) node 402(1). However, RSS node 402(1) adds to the overall structure of mapping template 302(1). For example, the channel node 402(2), item node 402(3), description node 402(3), and link node 402(4) are specific to the RSS node 402(1). In some implementations, the RSS node 402(1) may include full or summarized text as well as metadata associated with the text.

Mapping template(s) 302(1)-302(N) may be turned into the perspective of the input document tree based upon inferences made from one or more matching expressions. The matching expressions are determined on a forward only traversal of the input stream 112, emitting the corresponding optional tags 404(1)-404(4) as the traversal process proceeds.

In one implementation, the match expressions are plain paths, relative to expressions from their parent. For example, as illustrated in FIG. 4, the following matching expressions are attached to the destination node tree definition:

```
RSS/channel
item
    description/
    link/
```

Looking at this example, “RSS/channel” matches nodes named ‘channel’ that are children of ‘RSS’ nodes. Because this is a root level match expression, ‘RSS’ is the root of the mapping template. Next, ‘item’ is a relative match for nodes named ‘item’ and implies that these nodes are children of ‘channel’ because of the parent's match expression. Matches are generally relative to the parent's expression. Finally, ‘description/’ and ‘link/’ match the values of those nodes which are children of ‘item’. The trailing slash in ‘description/’ and ‘link/’ indicate a match with an anonymous child node of a node named ‘description’ or ‘link’. For example, in an XML document looks like <description>foo</description>which emits a start branch node named ‘description’ followed by an anonymous value ‘foo’. By adding the trailing slash, the anonymous value tokens may be extracted. A specific example is:

```
[ // RSS/channel
  { // item
desc : string, // description/
    link : string// link/
  }
]
```

Once the appropriate mapping template to be used during the transformation process is determined by the transformation engine 108, the transformation engine walks up and down the mapping template as the node is seen streaming in. The mapping tree may be pivoted into the perspective of the input stream 112 using the matching expressions described above. Therefore, the actual work performed by the transformation engine 108 to complete the transformation engine is minimal at the time of the transformation process. For example, the transformation engine 108 processes incoming data contained within input stream 112 as the input document streams over the network 104, without building up any intermediate per-request data structures.

In one implementation, the input stream 112 is transformed to a stream of tokens to be used by the transformation engine 108 to guide the transformation engine through the mapping template 302(1). In one implementation, the transformation engine 108 performs the transformation as follows: as tokens are streaming in over network 104, the transformation engine recognizes and moves to the RSS node 402(1); then, as the tokens continue to stream in, the transformation engine 108 recognizes and moves to the channel node 402(2) and emits an anonymous start vector; this process continues until the branch ends; the transformation engine 108 walks back up the mapping template 302(1) and any tokens the transformation engine does not recognize are ignored. An example of how the mapping template 302(1) can utilize the data from input stream 112 is as follows:

<bodytype=“vector”match=“RSS/channel”>
<itemtype=“object”match=“item”>
<desctype=“string”match=“description/” />
<linktype=“string”match=“link/” />
</item>
</body>

The code set forth above is defined in terms of the desired output structure and the type of each node. A match expression results, indicating where to find specific data in the mapping template. Multiple matches, such as “item” may produce multiple results.

In one implementation, a general notion of a serialized mapping template (or data tree) represented by a stream of tokens may be used. For example, when implemented in C#, the stream of tokens may be represented as an IEnumerable<token. In this example, each token consists of an optional ‘Name’ and an optional ‘Value’, both of which are strings, and a ‘type’ which may be a Start or End branch or leaf Using such a general notion, in one example, an XML character stream is converted to a token stream straightforwardly. Elements become named, valueless start/end nodes. Attributes become named leaf values. Text and CDATA become anonymous leaf values. In another example, JSON is converted to a token much the same way as XML characters. One small difference is that JSON allows for anonymous branch nodes (or objects) while XML has no such construct, only named branches-elements.

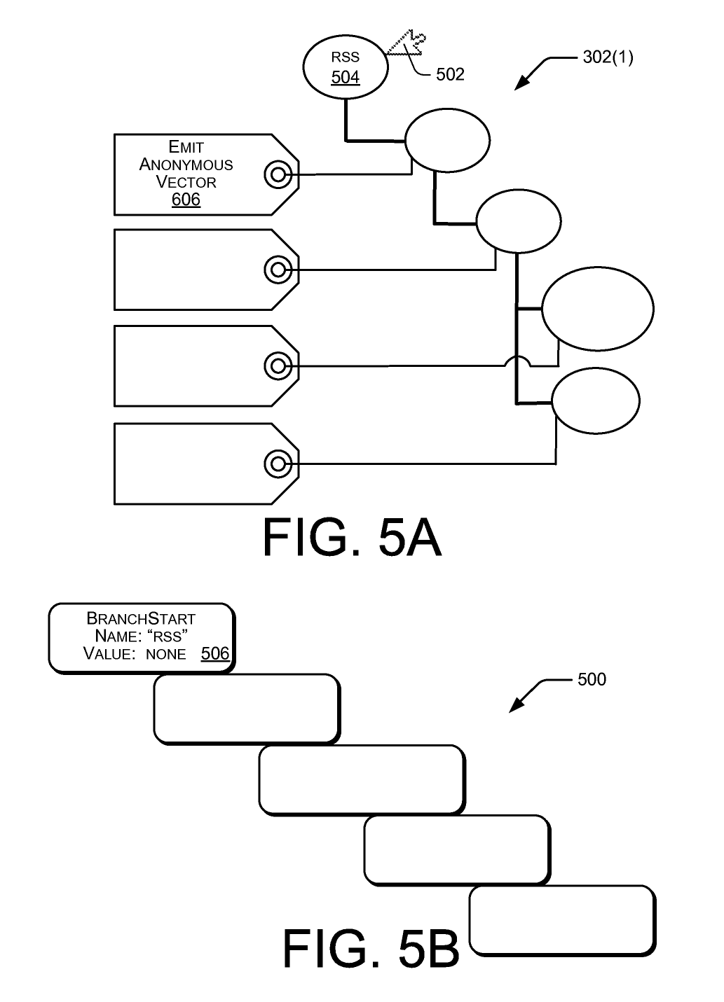

FIGS. 5-9 illustrate an example transformation process using the transformation engine 108. FIG. 5A illustrates an example mapping template 302(1) and FIG. 5B illustrates a token stream 500. As shown in FIG. 5A, following the mapping template 302(1), a cursor 502 follows the mapping template 302(1) in a forward-only traversal, recognizing a match with data presented from input stream 112. In this example, the ‘RSS’ node 504 BranchStart matches the root node in the input stream. However, in other examples, the node 504 may be represented by a SOAP feed, a JSON feed or any other structured data feed. Because the node 504 is not tagged to emit any output data, the cursor 502 moves on traversing the mapping template 302(1).

As discussed above, the mapping template 302(1) may also be represented as a token stream 500, illustrated in FIG. 5B. The ‘RSS’ node 504 is represented in the token stream 500 as a token 506.

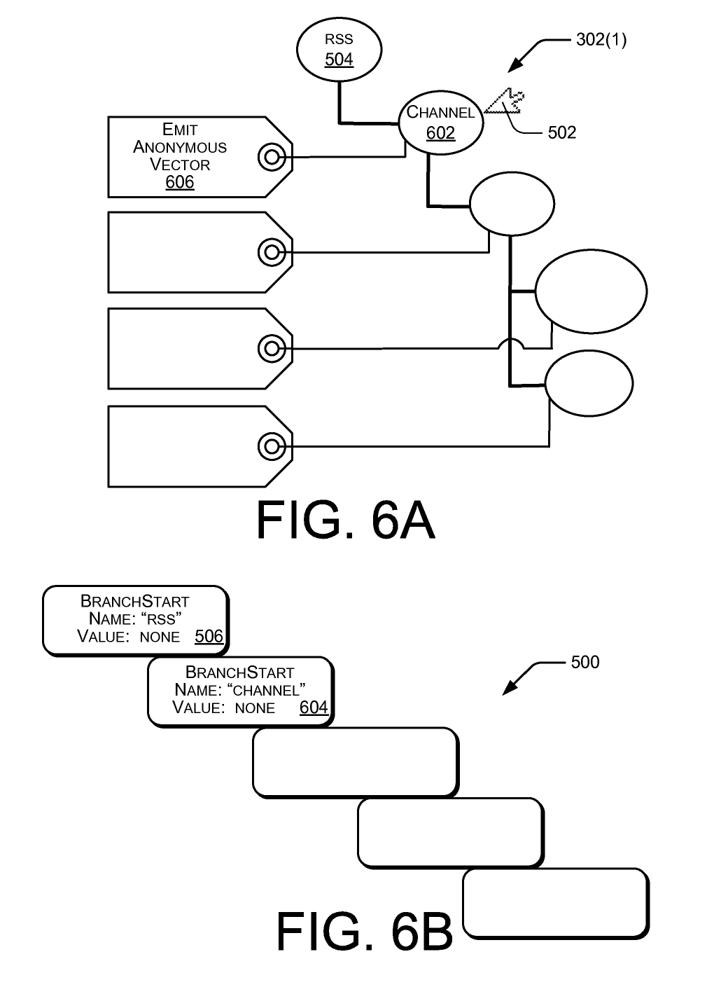

As illustrated in FIG. 6A the cursor 502 continues the forward traversal of mapping template 302(1) to ‘channel’ node 602. FIG. 6B illustrates that the token stream 500 continues with a token 604 corresponding to channel node 602. In this example, the ‘channel’ BranchStart token 604 is recognized by transformation engine 108, enabling cursor 502 shown in FIG. 6A to move to the channel node 602 and emit an anonymous vector 606. In one implementation, the anonymous vector may be in a customary binary format. The structure of the customary binary format preserves the structure of the data sent to and from the network services 110(1). Alternatively, the anonymous vector may be in any usable format.

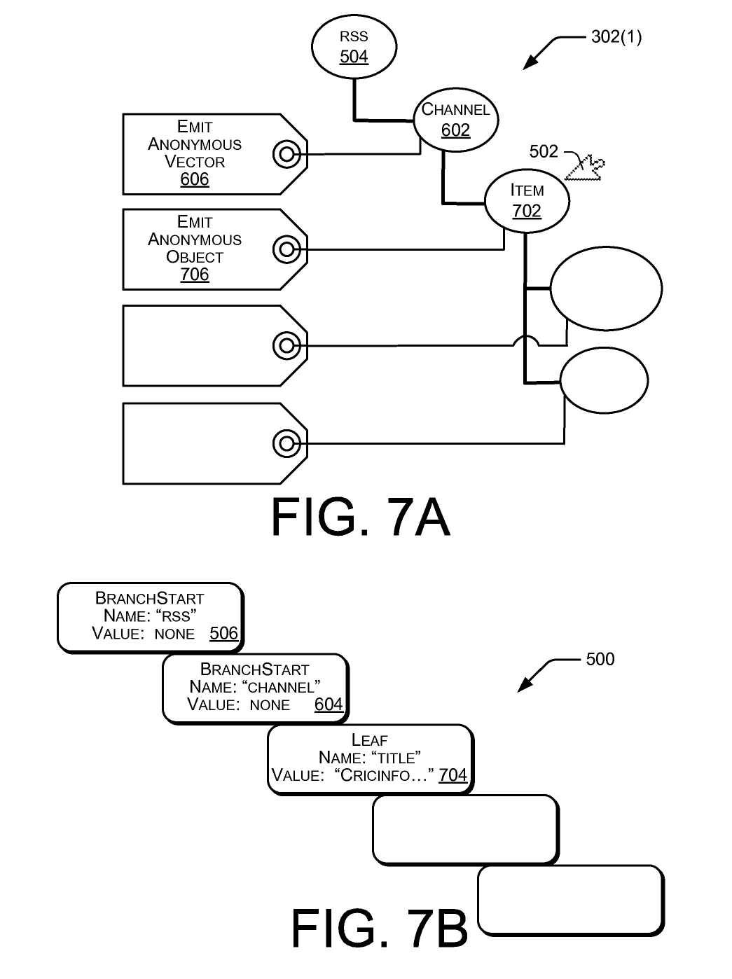

As illustrated in FIG. 7A the cursor 502 continues the forward traversal of mapping template 302(1) to ‘item’ node 702. FIG. 7B illustrates that the token stream 500 continues with a token 704 corresponding to item node 702. In this example, the corresponding token 704 is recognized by transformation engine 108, enabling cursor 502 shown in FIG. 7A to move to the item node 702 and emit an anonymous object 706. In one implementation, the anonymous object may be in a customary binary format. Alternatively, the anonymous object may be in any usable format.

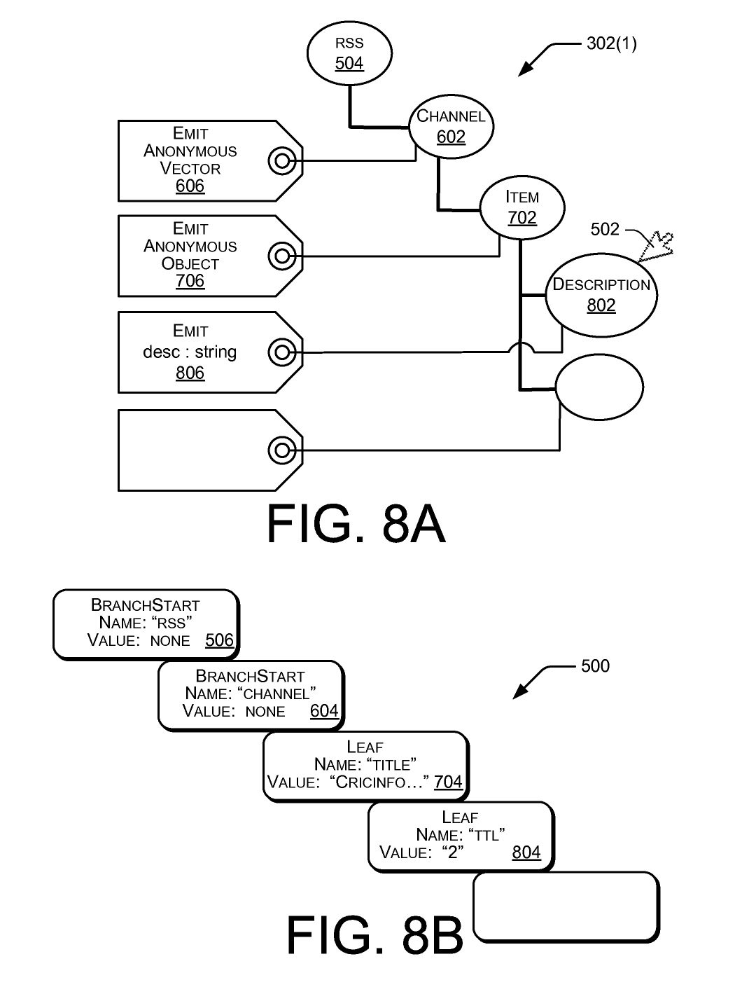

As illustrated in FIGS. 8A and 8B, this process continues the forward traversal of mapping template 302(1) to ‘description’ node 802. FIG. 8B illustrates that the token stream 500 continues with a token 804 corresponding to description node 802. In this example, the corresponding token 804 is recognized by transformation engine 108, enabling cursor 502 shown in FIG. 8A to move to the description node 802 and emit a string 806. In one implementation, the anonymous vector may be in a customary binary format. Alternatively, the anonymous vector may be in any usable format.

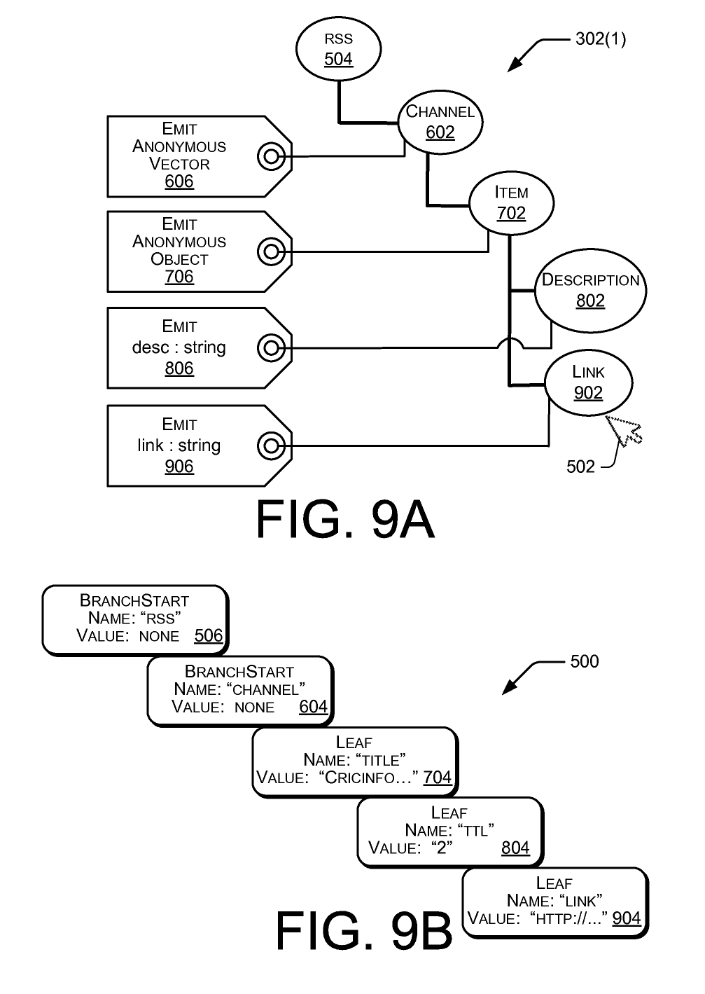

As illustrated in FIGS. 9A and 9B, this process continues the forward traversal of mapping template 302(1) to ‘link’ node 902. FIG. 9B illustrates that the token stream 500 continues with a token 904 corresponding to link node 802. In this example, the corresponding token 904 is recognized by transformation engine 108, enabling cursor 502 shown in FIG. 9A to move to the link node 902 and emit a string 906. In one implementation, the anonymous vector may be in a customary binary format. Alternatively, the anonymous vector may be in any usable format.

The cursor 502 traverses the mapping template 302(1) until a BranchEnd is identified. Once a BranchEnd is identified, the cursor 502 moves back up the mapping template 302(1) to the ‘channel’ node 602, ready to match the next item, if there are any, or move further up the mapping template 302(1) when a ‘channel’ BranchEnd is identified. Traversing the mapping template 302(1) as described above in FIGS. 5-9, enables a forward-only traversal of the data of input stream 112, permitting a custom binary format to be emitted to the output stream 114 immediately upon seeing a match. In one implementation, no intermediate state is maintained during the transformation processes described above with respect to FIGS. 5-9. Alternatively, it may be advantageous to permit a small intermediate state to be maintained. For example, in one implementation, a transformation process designated as a mode may be implemented. A mode transformation process would associate matches which only apply when the transformation engine 108 is in the designated mode. In another implementation, a transformation process includes a match which may emit a custom binary format or may trigger the transformation process to change to a mode permitting a small intermediate state to be maintained.

One example which may necessitate a small intermediate state would be the use of a search schema. An example search schema is:

```
<QueryResults>
<DomainResults>
<Domain>Local</Domain>
<Results>
<Item>
    ...
</Item>
</Results>
</DomainResults>
<DomainResults>
<Domain>Web</Domain>
<Results>
<Item>
      ...
</Item>
</Results>
</DomainResults>
  ...
</QueryResults>
```

As displayed in the example search schema above, there is no apparent way to specify a match against Result/Item nodes within the ‘Local’ domain set as opposed to the ‘Web’ domain, where a “DomainResults/Results/Item” would match either the Result node or the Item node. For example, filter expressions such as “DomainResults[Domain=‘Local’]/Results/Item” and “DomainResults[Domain=‘Web’]/Results/Item” may be generated to capture a match for the Result node and the Item node. Such a pattern may not be able to be evaluated in a forward-only manner because it is difficult, without breaking the schema, to change the order of elements such that the sibling node may not be seen in time. For example:

<DomainResults>0
<Results><!-- what kind of results are these?! -->
<Item>
...
</Item>
</Results>
<Domain>Web</Domain>
</DomainResults>

However, utilizing a simple mode concept, assumptions may be made about the order of the child or sibling nodes. In one implementation, a “SetMode” match occurs for “DomainResults/Domain/”, setting the mode to “Web” or “Local”. Alternative, matches may be scoped and arranged to work only in a particular mode.

Another example which may necessitate a mechanism involving a small intermediate state. The mechanism enables changing plain “Results” tokens to “WebResults” or “LocalResults” by remembering the “DomainResults/Domain/”. Specifically, a transformation object, such as an ITransformer object, may be employed to massage the token stream as the input stream 112 is transmitted over the network 104. For example, without limitation, when implemented in C#:

interfaceITransformer { IEnumerable<Token>
Transform(IEnumerable<Token> input); }

While the transformation process attempts to continue in the stream processing style described above with respect to FIGS. 5-9, the mechanism may accumulate data into any structure necessary to re-emit the data to the underlying system.

One example where the mechanism may be implemented is a search engine. For example, movie/theater/showtime results found during a search on a search engine are restructured, while each individual result remains intact and is re-emitted exactly as the movie time was received. This enables the mapping template layer to dominate the transformation process, and if the individual item changes, the transformation engine 108 would be agnostic and only the mapping template would be affected.

An example search template is:

```
<?xml version=“1.0” encoding=“utf-8” ?>
<service>
  <request>
  <url>http://api.someservice.com/Service.svc</url>
  <headers>
  <header name=“SOAPAction”
value=“http://schemas.someservice.com/v1” />
  </headers>
  <body>
    <![CDATA[
    <s:Envelope xmlns:s=“http://schemas.xmlsoap.org/soap/envelope/”>
    <s:Body>
    <Params xmlns=“http://schemas.someservice.com/v1”>
      <Foo>~foo~</Foo>
      <Bar>~bar~</Bar>
    </Params>
    </s:Body>
    </s:Envelope>
    ]]>
  </body>
  </request>
  <response>
  <![CDATA[
  <results type=“object” match=“Envelope/Body/Response”>
  <id type=“int” match=“GUID” />
    <records type=“vector” match=“Results”>
    <item type=“object” match=“Result”>
    <title type=“string” match=“Title/” />
    <address type=“object” match=“Address”>
      <street type=“string” match=“AddressLine/” />
      <district type=“string” match=“AdminDistrict/” />
      <city type=“string” match=“City/” />
    </address>
    <phone type=“string” match=“PhoneNumber/” />
    <email type=“string”
match=
“AdditionalProperties/KeyValueOfstringstring/EmailAddressValue/”
/>
  </item>
  </records>
  </results>
  ]]>
</response>
</service>
```

While this appears to be a lot of code, it replaces approximately three times as much custom code generally utilized by a search engine to conduct the requested search.

As illustrated in the example search template above, the search template comprises at least two portions, a request portion and a response portion. The request portion establishes parameters formulating the request, in this example movie times, while the response portion, utilizing the transformation process described above with respect to FIGS. 5-9, ensures an efficient transformation of the data in response to the request.

In one implementation, the ‘request’ section of the search template includes the universal resource locator (URL), one or more optional headers, and an optional POST body. Within each of the URL, optional headers, and optional POST body sections, there may be replacement tokens, for example, ˜replace_me˜. In one implementation, the replacement tokens are values taken from the query string of the transformation engine 108 request from the client. In this implementation, the replacement is carried out in a very efficient manner. The request URL, headers and body are broken into fragments surrounding the replacement tokens and are streamed out in chunks while slipping in the replacement values, avoiding parsing and allocations at the request-time. Replacement tokens may be in the form of ˜foo:bar˜, where the token is “foo”, with a default value “bar”.

Replacement tokens may specify a conversion factor to be applied to input parameters before substituting. For example, ˜{mapx}|foo:int˜ will convert a longitude, given by a parameter ‘foo’ into integer map coordinates ({mapy} would do the same for latitude).

Portions of the request template may be delimited by “conditional tokens” in the form of:
˜?foo=bar:default˜some content˜?foo˜

Generally, conditional tokens begin with ‘?’ and end with an “=bar” condition. This example corresponds with a parameter named “foo” for which, when “bar” is passed, it will include the “some content”. The “.default” is a default value used if “foo” isn't supplied. However, the content may contain replacement tokens, but cannot contain nested conditional blocks.

In this example, portions of the request template may be delimited by “repeater tokens” in the form:
˜!foo˜some content ˜!foo˜

Generally, repeater tokens begin with ‘!’. In this example, the parameter ‘foo’ is used to produce the repeated block. In one implementation, the repeated block is a UrlEncoded value that looks very similar to a query string. For example, the repeated block may have the form <set>&<set>& . . . , where the set is <pair1>|<pair2> . . . , where the pair is <name>=<value>. A specific example is:
. . . &foo=a%3Dfoo%7Cb%3D42%26a%3Dbar%7Cb%3Dbaz

This example may be decoded to:
a=foo|b=42&a=bar|b=baz

The decoded example above contains two pipe-separated sets of ‘a’ and ‘b’ parameters. This enables the repeater content to be emitted twice. Accordingly, within the repeater block, there are replacement tokens for the ‘a’ and ‘b’ parameters. For example, a template of:
This is ˜!repeat˜test˜a˜ing ˜b˜.˜!repeat˜ of repeaters.

Given the above sets of values for the ‘a’ and ‘b’ parameters, the result will be:
This is ˜!repeat˜test ˜*name˜ing ˜*value˜.˜!repeat˜ of repeaters.

Alternatively, the request parameters may be simplified to, foo=42&bar=baz, and the result will be the same.

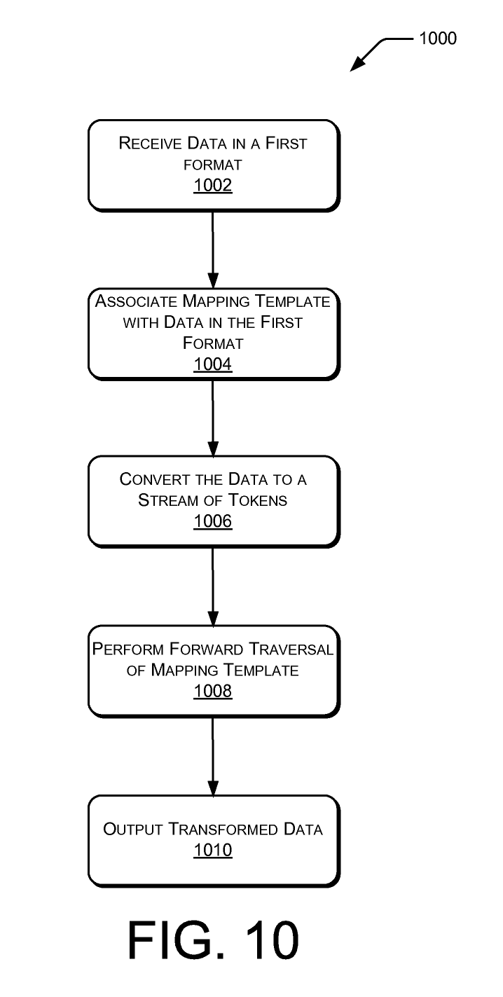

FIG. 10 illustrates a flow diagram of an example process 1000 outlining the data transformation process according to some implementations herein. In the flow diagram, the operations are summarized in individual blocks. The operations may be performed in hardware, or as processor-executable instructions (software or firmware) that may be executed by one or more processors. Further, the process 1000 may, but need not necessarily, be implemented using the framework of FIG. 1.

At block 1002, an input stream 112 in a first format is received by the transformation engine 108. In some implementations, the input stream 112 is in an XML format. However, in other implementations, the input stream 112 may be in a SOAP format, a JSON format, or any suitable format.

At block 1004, a mapping template is associated with the input stream 112. The mapping template may be modified to correspond to the perspective of the input source 112 using one or more matching expressions described above.

At block 1006, the input stream 112 is converted into a stream of tokens. The stream of tokens is used as a guide through the mapping template. In some implementations, when implemented in .NET, an ITransformer object may be employed within the token stream to manipulate the input stream 112.

At block 1008, a corresponding token is recognized by the transformation engine 108, enabling a forward transversal of the mapping template and the emission of an associated string. The associated string corresponds to information relating to output stream 114.

At block 1010, a transformed output stream 114 is created.

### CONCLUSION

Although a transformation process for the transformation of an input stream using a mapping template has been described in language specific to structural features and/or methods, it is to be understood that the subject of the appended claims are not necessarily limited to the specific features or methods described. Rather, the specific features and methods are disclosed as example implementations.

What is claimed is:

1. A computer-implemented method comprising:
receiving data in a first format over a network;
associating a mapping template with the data in the first format, the mapping template comprising:
one or more nodes; and
one or more tags, wherein a tag corresponds to a node;
performing a forward-traversal of the mapping template as the data is transmitted over the network free from an intermediate state; and
emitting a vector associated with a node recognized during the forward-traversal of the mapping template, the vector enabling output data to be transformed from the first format to a second format.

2. The computer-implemented method of claim 1 further comprising converting the data to a stream of one or more tokens used to guide through the mapping template, each token comprising a name and a value.

3. The computer-implemented method of claim 1, wherein the first format is an extensible markup language (XML) format, a simple object access protocol (SOAP) format, or a JavaScript object notation (JSON) format and the second format is a custom binary format.

4. The computer-implemented method of claim 1, wherein the mapping template is built prior to the association with data in the first format.

5. The computer-implemented method of claim 1, wherein the one or more nodes of the mapping template comprise at least one of a really simple syndication (RSS) node, a channel node, an item node, a description node, or a link node.

6. The computer-implemented method of claim 5, wherein a match expression is determined during the forward-traversal of the mapping template, the match expression comprising a plain path relative to a match expression of a node of the mapping template previously traversed.

7. The computer-implemented method of claim 1, wherein the tag associated with the node is determined concurrently with the forward-traversal of the mapping template proceeds.

8. A system comprising:
a memory;
one or more processors coupled to the memory;
a transformation engine operable on the one or more processors, the transformation engine configured to:
receive an input stream;
determine a mapping template associated with the input stream;
convert the input stream to a token stream comprising one or more tokens;
traverse the mapping template using the one or more tokens;
recognizing a node within the mapping template; and
emitting a vector associated with the recognized node, resulting in the production of an output stream.

9. The system of claim 8, wherein the input stream is in a first format and the output stream is in a second format.

10. The system of claim 8, wherein a BranchStart token in the token stream matches a root node in the input stream, determining the mapping template to be associated with the input stream.

11. The system of claim 8, wherein the traversing the mapping template is a forward-traversal free from an accumulation of an intermediate state.

12. The system of claim 8 further comprising associating a designated mode with the mapping template, the designated mode enabling a intermediate state to be maintained during the traversing of the mapping template.

13. The system of claim 8 further comprising correlating a node and an optional tag with the mapping template, the optional tag containing information in relation to the output stream.

14. The system of claim 13, wherein the mapping template comprises a channel node, an item node, a description node and a link node, all of which are specific to an a really simple syndication (RSS) node.

15. One or more computer-readable media storing computer-executable instructions that, when executed on one or more processors, cause the one or more processors to perform operations comprising:
receiving a data stream transmitted over a network and associating a mapping template with the data stream;
converting the data to a token stream comprising one or more tokens;
employing an ITransformer object within the token stream to manipulate the data stream; and
traversing the mapping template using the token stream as a guide, accumulating data into a structure to re-emit the data to an underlying system.

16. The one or more computer-readable media of claim 15, wherein the ITransformer object enables a result token in the token stream to be changed to a WebResults token or a LocalResults token.

17. The one or more computer-readable media of claim 16, wherein the result token comprises a universal resource locator (URL), an optional header, an optional POST body section, and a replacement token.

18. The one or more computer-readable media of claim 17, wherein the replacement token is a value taken from a query string of the request token, the replacement conducted by breaking the URL, the optional header, and the optional POST body section into one or more fragments surrounding the replacement token such that the one or fragments are streamed out in one or more chunks while slipping in the replacement token value.

19. The one or more computer-readable media of claim 15, wherein the ITransformer object is a replacement token, a conditional token, or a repeater token.

20. The one or more computer-readable media of claim 15, wherein the data stream comprises a result stream created during a search on a search engine.
